(19) United States
(12) Patent Application Publication
(10) Pub. No.: US 2011/0069058 A1
(43) Pub. Date: Mar. 24, 2011

(54) PIXEL CIRCUIT OF DISPLAY PANEL, METHOD OF CONTROLLING THE PIXEL CIRCUIT, AND ORGANIC LIGHT EMITTING DISPLAY INCLUDING THE DISPLAY PANEL

(76) Inventors: Bo-Yong Chung, Yongin-city (KR); Keum-Nam Kim, Yongin-city (KR)

(21) Appl. No.: 12/730,854

(22) Filed: Mar. 24, 2010

(30) Foreign Application Priority Data
Sep. 22, 2009 (KR) 10-2009-0089646

(51) Int. Cl. G09G 3/30; G09G 5/00

(52) U.S. Cl. 345/212; 345/76

(57) ABSTRACT

A pixel circuit of a display panel, a method of driving the pixel circuit, and an organic light emitting display device including the display panel are provided. All of a plurality of transistors used in the pixel circuit are NMOS transistors, and the pixel circuit is configured to compensate for a voltage change at a source electrode of a driving transistor during light emission.

### CROSS-REFERENCE TO RELATED PATENT APPLICATION

This application claims priority to and the benefit of Korean Patent Application No. 10-2009-0089646, filed on Sep. 22, 2009, in the Korean Intellectual Property Office, the disclosure of which is incorporated herein in its entirety by reference.

### BACKGROUND

1. Field

An aspect of an embodiment of the present invention relates to a pixel circuit of a display panel, a method of driving the pixel circuit, and an organic light emitting display device including the display panel.

2. Description of Related Art

Display devices receive image data from an external source and display images corresponding to the image data. Examples of the display devices include cathode ray tubes (CRTs), field emission displays (FEDs), liquid crystal displays (LCDs), and plasma display panels (PDPs).

Organic light emitting display devices using organic light emitting diodes (OLEDs) as organic light emitting devices have been recently developed and are being used in some products. In such organic light emitting display devices, a display panel includes a plurality of pixel circuits, and images may be displayed on the display panel by controlling the light emission of an OLED included in each of the pixel circuits. The pixel circuits included in the display panel affect the quality of display of the organic light emitting display devices. Much research into the structure of pixel circuits and driving methods thereof are being conducted.

### SUMMARY

An aspect of an embodiment of the present invention provides a pixel circuit of a display panel, capable of compensating for a voltage change at a source electrode of a driving transistor during light emission, a method of driving the pixel circuit, and an organic light emitting display device including the display panel.

According to an embodiment of the present invention, there is provided a pixel circuit for a display panel, including an organic light emitting diode (OLED) including an anode and a cathode; a first NMOS transistor including a first electrode coupled to a first node, a second electrode coupled to the anode of the OLED, and a gate electrode coupled to a second node; a second NMOS transistor including a first electrode coupled to the second node, a second electrode coupled to the first node, and a gate electrode; a third NMOS transistor including a first electrode coupled to a first power source, a second electrode coupled to the first node, and a gate electrode; a fourth NMOS transistor including a first electrode coupled to a data line, a second electrode coupled to a third node, and a gate electrode; a fifth NMOS transistor including a first electrode coupled to a reference power source, a second electrode coupled to the third node, and a gate electrode; a sixth NMOS transistor including a first electrode, a second electrode coupled to the anode of the OLED, and a gate electrode; a first capacitor coupled between the second node and the third node; a second capacitor coupled between the third node and the anode of the OLED; and a third capacitor coupled between the second node and the first electrode of the sixth NMOS transistor.

The gate electrode of the second NMOS transistor and the gate electrode of the fifth NMOS transistor may be configured to receive a previous scan signal.

The gate electrode of the fourth NMOS transistor may be configured to receive a current scan signal.

The gate electrode of the third NMOS transistor and the gate electrode of the sixth NMOS transistor may be configured to receive an emission signal.

The pixel circuit may further include a seventh NMOS transistor including a first electrode coupled to the first power source, a second electrode coupled to the first electrode of the sixth NMOS transistor, and a gate electrode configured to receive the current scan signal.

The reference power source may have a ground voltage.

The gate electrode of the second NMOS transistor and the gate electrode of the fourth NMOS transistor may be configured to receive a previous scan signal.

The gate electrode of the fifth NMOS transistor may be configured to receive a current scan signal.

The gate electrode of the third NMOS transistor and the gate electrode of the sixth NMOS transistor may be configured to receive an emission signal.

The gate electrode of the third NMOS transistor and the gate electrode of the sixth NMOS transistor may be configured to receive an external clock signal.

The pixel circuit may further include a seventh NMOS transistor including a first electrode coupled to the first power source, a second electrode coupled to the first electrode of the sixth NMOS transistor, and a gate electrode configured to receive the current scan signal.

The reference power source may have a logic high signal.

The first electrode of the first NMOS transistor may be a drain electrode and the second electrode of the first NMOS transistor may be a source electrode.

Capacitances of the first and second capacitors may be greater than capacitance of the third transistor.

According to another embodiment of the present invention, there is provided a method of driving a pixel circuit including an OLED having an anode and a cathode, a driving transistor, a plurality of switching transistors, a booster transistor having a first electrode, a second electrode coupled to the anode of the OLED, and a gate electrode, a plurality of capacitors, and a booster capacitor coupled between the gate electrode of the driving transistor and the first electrode of the booster transistor, wherein the driving transistor, the plurality of switching transistors and the booster transistor are NMOS transistors. The method includes turning on the booster transistor when a previous scan signal and a current scan signal are logic low and an emission signal is logic high, and transmitting a voltage change at the anode of the OLED to the gate electrode of the driving transistor via coupling of the booster capacitor.

The voltage change at the anode of the OLED may correspond to a voltage difference between a voltage at the anode when substantially no current flows through the OLED and a voltage at the anode when a current flows through the OLED.

The method may further include initializing the pixel circuit when the previous scan signal and the emission signal are logic high and the current scan signal is logic low.

The method may further include diode-connecting the driving transistor to compensate for a threshold voltage of the OLED when the previous scan signal is logic high and the current scan signal and the emission signal are logic low.

The method may further include performing data writing when the previous scan signal and the emission signal are logic low and the current scan signal is logic high.

According to another embodiment of the present invention, there is provided an organic light emitting display device including a scan driver for providing scan signals to a plurality of scan lines; an emission driver for providing emission signals to a plurality of emission control lines; a data driver for providing data signals to a plurality of data lines; and a plurality of pixel circuits at crossing regions between the scan lines, the emission control lines, and the data lines. Each of the pixel circuits includes an OLED including an anode and a cathode; a first NMOS transistor including a first electrode coupled to a first node, a second electrode coupled to the anode of the OLED, and a gate electrode coupled to a second node; a second NMOS transistor including a first electrode coupled to the second node, a second electrode coupled to the first node, and a gate electrode; a third NMOS transistor including a first electrode coupled to a first power source, a second electrode coupled to the first node, and a gate electrode; a fourth NMOS transistor including a first electrode coupled to a data line, a second electrode coupled to a third node, and a gate electrode; a fifth NMOS transistor including a first electrode coupled to a reference power source, a second electrode coupled to the third node, and a gate electrode; a sixth NMOS transistor including a first electrode, a second electrode coupled to the anode of the OLED, and a gate electrode; a first capacitor coupled between the second node and the third node; a second capacitor coupled between the third node and the anode of the OLED; and a third capacitor coupled between the second node and the first electrode of the sixth NMOS transistor.

The gate electrode of the second NMOS transistor and the gate electrode of the fifth NMOS transistor may be coupled to an (N−1)th scan line, wherein N is a natural number satisfying 0<N<n. The gate electrode of the third NMOS transistor and the gate electrode of the sixth NMOS transistor may be coupled to an N-th emission control line. The gate electrode of the fourth NMOS transistor may be coupled to an N-th scan line.

The gate electrode of the second NMOS transistor and the gate electrode of the fourth NMOS transistor may be coupled to an (N−1)th scan line, wherein N is a natural number satisfying 0<N<n. The gate electrode of the third NMOS transistor and the gate electrode of the sixth NMOS transistor may be coupled to an N-th emission control line. The gate electrode of the fifth NMOS transistor may be coupled to an N-th scan line.

The organic light emitting display device may further include a seventh NMOS transistor including a first electrode coupled to the first power source, a second electrode coupled to the first electrode of the sixth NMOS transistor, and a gate electrode coupled to the N-th scan line.

The first electrode of the first NMOS transistor may be a drain electrode and the second electrode of the first NMOS transistor may be a source electrode.

Capacitances of the first and second capacitors may be greater than capacitance of the third transistor.

### BRIEF DESCRIPTION OF THE DRAWINGS

The above and other features and aspects of the present invention will become more apparent by describing in detail exemplary embodiments thereof with reference to the attached drawings in which:

FIG. 1 is a circuit diagram of a pixel circuit of a display panel, according to an embodiment of the present invention;

FIG. 2 is a timing diagram for describing a method of driving the pixel circuit illustrated in FIG. 1, according to an embodiment of the present invention;

FIG. 3 is a circuit diagram of a pixel circuit of a display panel, according to another embodiment of the present invention;

FIG. 4 is a circuit diagram of a pixel circuit of a display panel, according to another embodiment of the present invention;

FIG. 5 is a circuit diagram of a pixel circuit of a display panel, according to another embodiment of the present invention;

FIG. 6 is a circuit diagram of a pixel circuit of a display panel, according to another embodiment of the present invention;

FIG. 7 is a circuit diagram of a pixel circuit of a display panel, according to another embodiment of the present invention; and

FIG. 8 is a block diagram of an organic light emitting display device according to an embodiment of the present invention.

### DETAILED DESCRIPTION

Hereinafter, embodiments of the present invention will be described in detail by explaining various embodiments of the invention with reference to FIGS. 1 through 8. Here, when a first element is described as being coupled or connected to a second element, the first element may be directly coupled to the second element or indirectly coupled to the second element via a third element.

FIG. 1 is a circuit diagram of a pixel circuit of a display panel, according to an embodiment of the present invention.

Referring to FIG. 1, the pixel circuit according to one embodiment includes an organic light emitting diode (OLED), a driving transistor (a first transistor M1), a plurality of switching transistors (second through sixth transistors M2 through M6), and a plurality of capacitors (first through third capacitors C1, C2 and Cis), and all of the transistors included in the pixel circuit are NMOS transistors. In the display panel, a plurality of the pixel circuits may be arranged in an n×m matrix. The pixel circuit illustrated in FIG. 1 corresponds to a pixel circuit located in an N-th row and an M-th column.

The OLED includes an anode and a cathode, wherein the cathode is connected to a second power source. The OLED generates light by using a current generated by the driving transistor. The brightness of the light depends on the magnitude of the current flowing through the OLED.

Referring to FIG. 1, the first transistor M1 includes a first electrode connected to a first node N1, a second electrode connected to the anode of the OLED, and a gate electrode connected to a second node N2. The first electrode of the first transistor M1 may be a drain electrode, and the second electrode of the first transistor M1 may be a source electrode. The first transistor M1 operates as the driving transistor, and generates a current depending on a voltage Vgs between the gate electrode and the source electrode and outputs the current to the OLED. Hereinafter, the terms “first transistor” and “driving transistor” will be used interchangeably.

The second transistor M2 includes a first electrode connected to the second node N2 and a second electrode connected to the first node N1. The second transistor M2 also includes a gate electrode to which an external control signal is applied. The second transistor M2 is connected between the first electrode and the gate electrode of the driving transistor M1, and when the second transistor M2 is turned on by the external control signal, the second transistor M2 connects the driving transistor M1 to be in a diode connection (or diode-connected) state. The diode connection of the driving transistor M1 may compensate for a threshold voltage Vth of the driving transistor M1 and a threshold voltage Vto of the OLED, which is present between the anode and the cathode of the OLED during non-emission. The external control signal corresponds to a previous scan signal, which is a scan signal provided from an (N−1)th scan line S[N−1] that is a previous scan line. Thus, the gate electrode of the second transistor M2 is connected to the previous scan line S[N−1].

The third transistor M3 includes a first electrode connected to a first power source and a second electrode connected to the first node N1. The third transistor M3 also includes a gate electrode to which an external control signal is applied. When the third transistor M3 is turned on according to the external control signal, the third transistor M3 applies a first power supply voltage ELVDD to the first electrode of the driving transistor M1. Since the third transistor M3 is turned on, a current is generated by the driving transistor M1, and the current flows to the OLED. The external control signal is an emission signal and is provided from an N-th emission control line EM[N]. Thus, the gate electrode of the third transistor M3 is connected to the N-th emission control line EM[N].

The fourth transistor M4 includes a first electrode connected to an M-th data line D[M] and a second electrode connected to a third node N3. The fourth transistor M4 also includes a gate electrode to which an external control signal is applied. When the fourth transistor M4 is turned on according to the external control signal, a data voltage Vdata provided from the M-th data line D[M] is applied to the third node N3. The external control signal is a current scan signal provided from an N-th scan line S[N], that is a current scan line. Thus, the gate electrode of the fourth transistor M4 is connected to the current scan line S[N].

The fifth transistor M5 includes a first electrode connected to a reference power source and a second electrode connected to the third node N3. The fifth transistor M5 also includes a gate electrode to which an external control signal is applied. When the fifth transistor M5 is turned on according to the external control signal, a reference voltage Vref provided from the reference power source is applied to the third node N3. The external control signal may be the previous scan signal that is applied to the gate electrode of the second transistor M2. Thus, the gate electrode of the fifth transistor M5 is connected to the previous scan line S[N−1].

The sixth transistor M6 includes a first electrode connected to the third capacitor Cis and a second electrode connected to the anode of the OLED. The sixth transistor M6 also includes a gate electrode to which an external control signal is applied. When the sixth transistor M6 is turned on according to the external control signal, a voltage of the anode of the OLED is applied to one terminal of the third capacitor Cis. The external control signal may be the emission signal that is applied to the gate electrode of the third transistor M3. Thus, the gate electrode of the sixth transistor M6 is connected to the N-th emission control line EM[N].

The second through sixth transistors M2 through M6 serve as the switching transistors.

The first capacitor C1 includes a first terminal connected to the third node N3 and a second terminal connected to the second node N2.

The second capacitor C2 includes a first terminal connected to the third node N3 and a second terminal connected to the anode of the OLED.

The third capacitor Cis includes a first terminal connected to the second node N2 and a second terminal connected to the first electrode of the sixth transistor M6, which is connected to the fifth node N5. When the sixth transistor M6 is turned on according to the emission signal, the voltage of the anode of the OLED is applied to the second terminal of the third capacitor Cis. Due to the coupling of capacitors, a voltage change at the first terminal of the third capacitor Cis, which is connected to the gate electrode of the driving transistor M1, corresponds to a voltage change at the second terminal of the third capacitor Cis.

When a capacitance of the first capacitor C1 is c1, a capacitance of the second capacitor C2 is c2, and a capacitance of the third capacitor Cis is cis, a condition of c1>>cis, c2>>cis is satisfied.

The first power source provides the first power supply voltage ELVDD, and the second power source provides a second power supply voltage ELVSS. The second power supply voltage ELVSS may be a ground voltage GND. The reference power source may provide a reference voltage Vref, which may be a ground voltage GND.

As described above, all of the transistors included in the pixel circuit according to the described embodiment are NMOS transistors. In a conventional pixel circuit, PMOS transistors may be used. Since crystalline silicon is used to manufacture PMOS-type thin film transistors (TFTs), an Excimer Laser Annealing (ELA) device, which is a crystallization device, is used.

However, when a pixel circuit uses NMOS transistors, the following characteristics exist.

First, a TFT may be manufactured using amorphous silicon (a-Si), and thus an ELA device, which is expensive, is not used.

Second, the number of masks used may be reduced when a pixel circuit using NMOS transistors is produced, compared with when a pixel circuit using PMOS transistors is produced.

Third, when NMOS transistors are used, it is possible to use oxide TFTs. When oxide TFTs are used, voltage uniformity, which is a characteristic of amorphous silicon, and a high electron mobility, which is a characteristic of Low-Temperature Poly-Silicon (LTPS), can be achieved. This facilitates an improvement of the life span of a display panel and realization of a high resolution.

In the case of LCDs, pixel circuits are manufactured by using only NMOS transistors. Thus, equipment for manufacturing LCDs may be used in manufacturing the pixel circuit according to an embodiment of the present invention, resulting in cost savings.

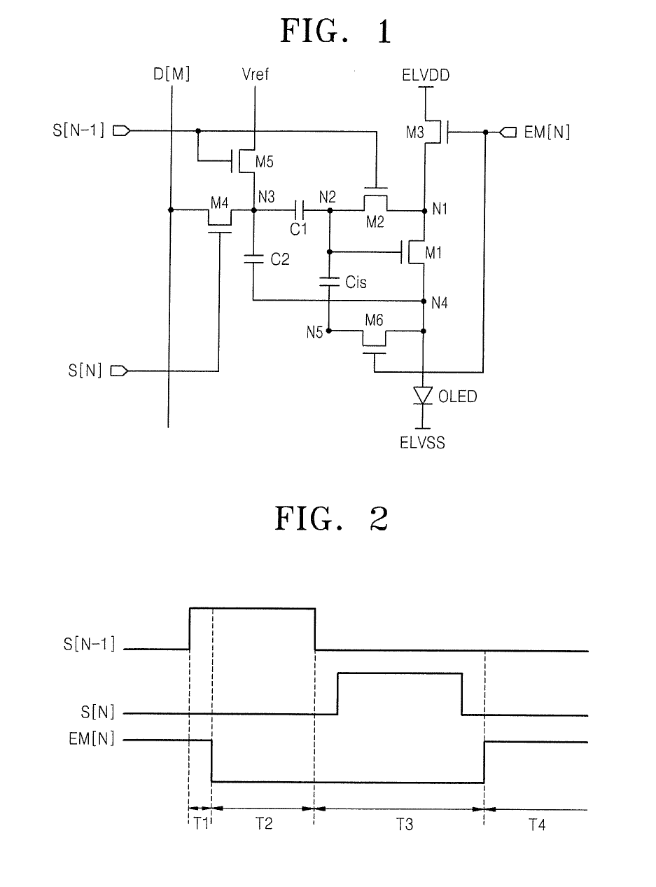

An operation of the pixel circuit of FIG. 1 will now be described with reference to FIG. 2.

FIG. 2 is a timing diagram for describing a method of driving the pixel circuit illustrated in FIG. 1, according to one embodiment.

Overall operation of the pixel circuit is divided into first through fourth intervals T1 through T4. An operation of the pixel circuit in each of the first through fourth intervals T1 through T4 will now be described.

In the first interval T1, initialization is performed.

In the first interval T1, the previous scan signal is supplied to the previous scan line S[N−1], and the emission signal is supplied to the emission control line EM[N]. In other words, the previous scan signal and the emission signal are logic high in the first interval T1. The second, third, fifth, and sixth transistors M2, M3, M5, and M6 are turned on by the previous scan signal and the emission signal, and thus each node of the pixel circuit is initialized. Here, the current scan signal applied to the current scan line S[N] is logic low.

In the second interval T2, the driving transistor M1 is diode-connected to compensate for the threshold voltage Vto of the OLED and the threshold voltage Vth of the driving transistor M1.

In the second interval T2, the previous scan signal is logic high, and the current scan signal and the emission signal are logic low. According to the previous scan signal, the second and fifth transistors M2 and M5 are turned on. Since the anode of the OLED is connected to the fourth node N4 and the threshold voltage of the OLED is Vto, a voltage Vn4 of the fourth node N4 is ELVSS+Vto. Since the driving transistor M1 is diode-connected, a voltage Vn2 of the second node N2 is ELVSS+Vto+Vth. A voltage Vn3 of the third node N3 becomes the reference voltage Vref. A voltage Vn5 of the fifth node N5 becomes ELVSS+Vto. The voltages of the second to fifth nodes N2 to N5 of the pixel circuit in the second interval T2 are summarized as follows.

N2: Vn2=ELVSS+Vto+Vth

N3: Vn3=Vref

N4: Vn4=ELVSS+Vto

N5: Vn5=ELVSS+Vto

In the third interval T3, data writing is performed.

In the third interval T3, the current scan signal is logic high, and the previous scan signal and the emission signal are logic low. When the fourth transistor M4 is turned on by the current scan signal, the data voltage Vdata is applied to the third node N3. Since the fifth node N5 is in a floating state, a voltage change at the third node N3 is reflected at the second node N2. The voltages of the second to fifth nodes N2 to N5 of the pixel circuit in the third interval T3 are summarized as follows.

N2: Vn2=ELVSS+Vto+Vth+ΔV1=ELVSS+Vto+Vth+Vdata−Vref

N3: Vn3=Vdata(ΔV1=Vdata−Vref)

N4: Vn4=ELVSS+Vto

N5: Vn5=ELVSS+Vto+ΔV1=ELVSS+Vto+Vdata−Vref=ELVSS+Va

In the fourth interval T4, degradation of the OLED is compensated for. The compensation for the degradation of the OLED may be achieved by accounting for the voltage change at the anode of the OLED in the voltage applied to the gate electrode of the driving transistor M1.

In the fourth interval T4, the emission signal is logic high, and the previous scan signal and the current scan signal are logic low. The third and sixth transistors M3 and M6 are turned on by the emission signal. Since the third transistor M3 is turned on, a current flows through the OLED. When the OLED enters into an emission state due to the flow of the current therein, the voltage Vn4 of the fourth node N4, which is connected to the anode of the OLED, is changed. When a voltage between the anode and cathode of the OLED during light emission is Voled, the voltage Vn4 is ELVSS+Voled. The voltage Voled varies according to the degree of degradation of the OLED. When the sixth transistor M6 is turned on, the voltages Vn4 and Vn5 of the fourth and fifth nodes N4 and N5 are changed to ELVSS+Voled, and thus the voltage Vn2 of the second node N2 is also changed. In other words, the third capacitor Cis and the sixth transistor M6 serve as a boost capacitor and a boost transistor, respectively. Calculating the voltage change of the voltage Vn2, a voltage variation of the voltage Vn2 depending on the voltage change of the fourth node N4 is ΔV2*{cs/(cs+cis)} and a voltage variation of the voltage Vn2 depending on the voltage change of the fifth node N5 is ΔV3*{cis/(cs+cis)}, where ΔV2=Voled−Vto, ΔV3=Voled−Va, and cs denotes a composite capacitance when the first and second capacitors C1 and C2 are connected to each other in series. The voltages of the second, fourth and fifth nodes N2, N4 and N5 of the pixel circuit in the fourth interval T4 are summarized based on this calculation, as follows.

$$\begin{matrix}N 2 \text{:} Vn 2 = ELVSS + Vto + Vth + Vdata - Vref + \\ = Δ V 2 * \{ cs / ( cs + cis ) \} + Δ V 3 * \{ cis / ( cs / cis ) \} \\ ELVSS + Vto + Vth + Vdata - Vref + \\ ( Voled - Vto ) * \{ cs / ( cs + cis ) \} + ( Voled - Va ) * \\ \{ cis / ( cs + cis ) \}\end{matrix}$$

N4: Vn4=ELVSS+Voled(ΔV2=Voled−Vto)

N5: Vn5=ELVSS+Voled(ΔV3=ELVSS+Voled−(ELVSS+Va)=Voled−Va)

The voltage Vn2 of the second node N2 is the voltage of the gate electrode of the driving transistor M1, and the voltage Vn4 of the fourth node N4 is the voltage of the source electrode of the driving transistor M1. In view of a condition of c1, c2>>cis, cs>>cis, accordingly,

$$\begin{matrix}Vg = Vn 2 \\ \approx ELVSS + Vto + Vth + Vdata - Vref + ( Voled - Vto ) + \\ = ( Voled - Va ) * \{ cis / cs \} \\ = ELVSS + Vth + Vdata - Vref + Voled + \\ ( Voled - Va ) * \{ cis / cs \} \\ Vs = Vn 4 \\ = ELVSS + Voled .\end{matrix}$$

A current I flowing through the OLED according to the voltages of the driving transistor M1 is calculated as follows:

$$\begin{matrix}I = ( β / 2 ) {( Vgs - Vth )}^{2} \\ = ( β / 2 ) {( Vg - Vs - Vth )}^{2} \\ = ( β / 2 ) \{ ELVSS + Vth + Vdata - Vref + Voled + \\ ( Voled - Va ) ( cis / cs ) - ( ELVSS + Voled ) - {Vth}^{2} \\ = ( β / 2 ) {\{ Vdata - Vref + ( Voled - Va ) ( cis / cs ) \}}^{2} ,\end{matrix}$$

wherein β denotes a gain factor.

With the above-described current I flowing through the OLED, it may be known that the voltage Voled varying according to the degradation of the OLED is reflected in the current.

As described above, in the pixel circuit and the pixel circuit driving method according to the described embodiment, the voltage change of the anode of the OLED due to the degradation of the OLED may be reflected in the voltage applied at the gate electrode of the driving transistor M1 by using the sixth transistor M6 and the third capacitor Cis. Accordingly, display performance of the organic light emitting display device may be prevented from degrading.

Table 1 shows a result of a simulation performed on the pixel circuit of FIG. 1.

TABLE 1

| | Before degradation | After degradation |
|---|---|---|
| Vn5(V) | 4.62 | 5.12 |
| Vn2(V) | 2.57 | 3.05 |

As shown in Table 1, the voltage Vn5 increases as the OLED degrades, and the voltage Vn2 increases as the voltage Vn5 increases.

Table 2 shows a result of another simulation performed on the pixel circuit of FIG. 1.

TABLE 2

| | Vn2(V) | Vn4(V) | I(A) | ΔI(A) |
|---|---|---|---|---|
| Standard | 8.72 | 5.97 | 1.01E−06 | 0.00E+00 |
| Degradation 1 | 9.45 | 6.65 | 1.09E−06 | 8.13E−08 |
| Degradation 2 | 10.18 | 7.35 | 1.18E−06 | 1.63E−07 |

“Standard” denotes a case where no degradation of the OLED occurs, and “Degradation 1” and “Degradation 2” denote the cases where the OLED degrades. The degradation of the OLED is greater in the case of “Degradation 2” than in the case of “Degradation 1.”

As shown in Table 2, as the voltage Vn4 increases, the voltage Vn2 increases accordingly. Accordingly, the current flowing through the OLED also increases.

Since luminous efficiency is lower in the cases where the OLED degrades than in the case where no degradation of the OLED occurs, the current flowing through the OLED is increased so that a gray level that is the same as a gray level represented in the case where no degradation of the OLED occurs is represented in a degraded OLED. Accordingly, based on Table 1 and Table 2, the capacitance cis of the third capacitor Cis is controlled to adjust the voltage variation of the voltage Vn2. As a result, the current flowing through the OLED may be controlled.

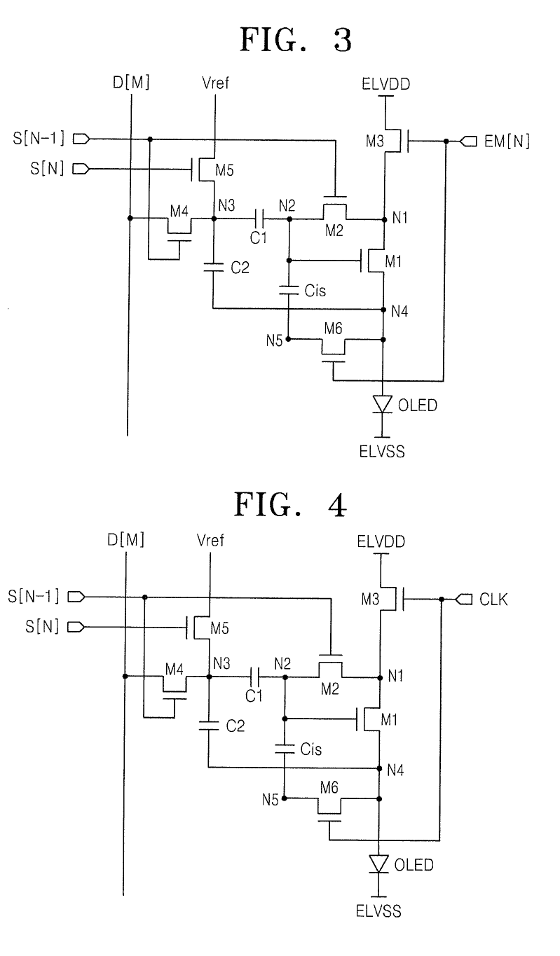

FIG. 3 is a circuit diagram of a pixel circuit of a display panel according to another embodiment of the present invention.

Referring to FIG. 3, the pixel circuit according to another embodiment includes an OLED, first through sixth transistors M1 through M6, and first through third capacitors C1, C2 and Cis. The connections between these devices are substantially the same as those of the pixel circuit of FIG. 1. Accordingly, descriptions of the same structure and operation as those of the pixel circuit of FIG. 1 will not be repeated, and the pixel circuit according to another embodiment will now be described by focusing on differences between the pixel circuits of FIGS. 3 and 1.

In the embodiment of FIG. 3, the previous scan signal is applied to the gate electrodes of the second and fourth transistors M2 and M4. Thus, the gate electrodes of the second and fourth transistors M2 and M4 are connected to the previous scan line S[N−1].

The current scan signal is applied to the gate electrode of the fifth transistor M5. Accordingly, the gate electrode of the fifth transistor M5 is connected to the current scan line S[N].

The emission signal is applied to the gate electrodes of the third and sixth transistors M3 and M6. Accordingly, the gate electrodes of the third and sixth transistors M3 and M6 are connected to the emission control line EM[N].

The first power source provides the first power supply voltage ELVDD, and the second power source provides the second power supply voltage ELVSS. The second power supply voltage ELVSS may be a ground voltage GND. The reference power source may provide the reference voltage Vref, which may be a logic high voltage.

The operations of the pixel circuits of FIGS. 1 and 3 are substantially the same, and the pixel circuits of FIGS. 1 and 3 operate according to the timing diagram of FIG. 2. However, in the embodiment of FIG. 3, the fourth transistor M4 is first turned on, and the fifth transistor M5 is then turned on, and thus a current I finally flowing through the OLED is calculated as follows:

I=(β/2){Vref−Vdata+(Voled−Va)(cis/cs)}².

FIG. 4 is a circuit diagram of a pixel circuit of a display panel according to another embodiment of the present invention.

Referring to FIG. 4, the pixel circuit according to another embodiment includes an OLED, first through sixth transistors M1 through M6, and first through third capacitors C1, C2 and Cis. The connections between these devices are substantially the same as those of the pixel circuit of FIG. 3. Accordingly, descriptions of the same structure and operation as those of the pixel circuit of FIG. 3 will not be repeated, and the pixel circuit according to the embodiment of FIG. 4 will now be described by focusing on differences between the pixel circuits of FIGS. 4 and 3.

In the embodiment of FIG. 4, the previous scan signal is applied to the gate electrodes of the second and fourth transistors M2 and M4. Thus, the gate electrodes of the second and fourth transistors M2 and M4 are connected to the previous scan line S[N−1].

The current scan signal is applied to the gate electrode of the fifth transistor M5. Accordingly, the gate electrode of the fifth transistor M5 is connected to the current scan line S[N].

In the embodiment of FIG. 4, a clock signal CLK instead of the emission signal is applied to the gate electrodes of the third and sixth transistors M3 and M6. The clock signal CLK may be generated from a system clock. In this case, a special driving unit for generating the emission signal is not used.

Like the pixel circuit of FIG. 3, a current I flowing through the OLED of the pixel circuit of FIG. 4 is calculated as follows: I=(β/2){Vref−Vdata+(Voled−Va)(cis/cs)}².

As described above, in the pixel circuit and the pixel circuit driving method according to the embodiment of FIG. 4, even if the types of signals applied to the second through sixth transistors M2 through M6 are changed, the voltage change of the anode of the OLED caused due to the degradation of the OLED may be reflected in the voltage applied at the gate electrode of the driving transistor M1 by using the sixth transistor M6 and the third capacitor Cis. Accordingly, display performance of the display panel including the pixel circuit of FIG. 3 or FIG. 4 may be prevented from degrading.

FIG. 5 is a circuit diagram of a pixel circuit of a display panel according to another embodiment of the present invention.

Referring to FIG. 5, the pixel circuit according to another embodiment includes an OLED, first through seventh transistors M1 through M7, and first through third capacitors C1, C2 and Cis. The connections between these devices are substantially the same as those of the pixel circuit of FIG. 1. Accordingly, descriptions of the same structure and operation as those of the pixel circuit of FIG. 1 will not be repeated, and the pixel circuit according to the embodiment of FIG. 5 will now be described by focusing on differences between the pixel circuits of FIGS. 5 and 1.

In the embodiment of FIG. 5, the seventh transistor M7 is further included in addition to the pixel circuit of FIG. 1.

The seventh transistor M7 includes a first electrode connected to the first power source and a second electrode connected to the first electrode of the sixth transistor M6. The seventh transistor M7 also includes a gate electrode to which an external control signal is applied. When the seventh transistor M7 is turned on by the external control signal, the first power supply voltage ELVDD is applied to the fifth node N5. The external control signal may be the current scan signal, which is applied to the gate electrode of the fourth transistor M4. Accordingly, the gate electrode of the seventh transistor M7 is connected to the current scan line S[N].

The first power source provides the first power supply voltage ELVDD, and the second power source provides the second power supply voltage ELVSS. The second power supply voltage ELVSS may be a ground voltage GND. The reference power source may provide the reference voltage Vref, which may be a ground voltage GND.

An operation of the pixel circuit of FIG. 5 will now be described with reference to the timing diagram of FIG. 2.

In the first interval T1, initialization is performed.

In the first interval T1, the previous scan signal is supplied to the previous scan line S[N−1], and the emission signal is supplied to the emission control line EM[N]. In other words, the previous scan signal and the emission signal are logic high in the first interval T1. The second, third, fifth, and sixth transistors M2, M3, M5, and M6 are turned on by the previous scan signal and the emission signal, and thus each node of the pixel circuit is initialized. Here, the current scan signal applied to the current scan line S[N] is logic low.

In the second interval T2, the driving transistor M1 is diode-connected to compensate for the threshold voltage Vto of the OLED and the threshold voltage Vth of the driving transistor M1.

In the second interval T2, the previous scan signal is logic high, and the current scan signal and the emission signal are logic low. According to the previous scan signal, the second and fifth transistors M2 and M5 are turned on. When the anode of the OLED is connected to the fourth node N4 and the threshold voltage of the OLED is Vto, a voltage Vn4 of the fourth node N4 is ELVSS+Vto. Since the driving transistor M1 is diode-connected, a voltage Vn2 of the second node N2 is ELVSS+Vto+Vth. A voltage Vn3 of the third node N3 becomes the reference voltage Vref. A voltage Vn5 of the fifth node N5 is ELVSS+Vto. The voltages of the second to fifth nodes N2 to N5 of the pixel circuit of FIG. 5 in the second interval T2 are summarized as follows.

N2: Vn2=ELVSS+Vto+Vth

N3: Vn3=Vref

N4: Vn4=ELVSS+Vto

N5: Vn5=ELVSS+Vto

In the third interval T3, data writing is performed.

In the third interval T3, the current scan signal is logic high, and the previous scan signal and the emission signal are logic low. When the fourth transistor M4 is turned on by the current scan signal, the data voltage Vdata is applied to the third node N3. In addition, the seventh transistor M7 is turned on, and thus the first power supply voltage ELVDD is applied to the fifth node N5. Voltage changes of the third node N3 and the fifth node N5 are reflected in the second node N2, and a voltage change of the second node N2 is calculated as follows. A voltage variation of the voltage Vn2 according to the voltage change of the third node N3 is ΔV4*{c1/(c1+cis)}, and a voltage variation of the voltage Vn2 according to the voltage change of the fifth node N5 is ΔV5*{cis/(c1+cis)}. Here, ΔV4 is Vdata−Vref, and ΔV5 is ELVDD-(ELVSS+Vto). The voltages of the second to fifth nodes N2 to N5 of the pixel circuit of FIG. 5 in the third interval T3 are summarized based on this calculation, as follows.

$$\begin{matrix}N 2 \text{:} Vn 2 = ELVSS + Vto + Vth + Δ V 4 * \{ c 1 / ( c 1 + cis ) \} + \\ Δ V 5 * \{ cis / ( c 1 + cis ) \} \\ = ELVSS + Vto + Vth + ( Vdata - Vref ) * \\ \{ c 1 / ( c 1 + cis ) \} + \{ ELVDD - ( ELVSS + Vto ) \} * \\ \{ cis / ( c 1 + cis ) \}\end{matrix}$$

N3: Vn3=Vdata(ΔV4=Vdata−Vref)

N4: Vn4=ELVSS+Vto

N5: Vn5=ELVDD(ΔV5=ELVDD−(ELVSS+Vto))

In the fourth interval T4, degradation of the OLED is compensated for. The compensation for the degradation of the OLED may be achieved by accounting for the voltage change occurring at the anode of the OLED in the voltage applied to the gate electrode of the driving transistor M1.

In the fourth interval T4, the emission signal is logic high, and the previous scan signal and the current scan signal are logic low. The third and sixth transistors M3 and M6 are turned on by the emission signal. Since the third transistor M3 is turned on, a current flows through the OLED. When the OLED enters into an emission state due to the flow of the current therein, the voltage Vn4 of the fourth node N4, which is connected to the anode of the OLED, is changed. When a voltage between the anode and cathode of the OLED during light emission is Voled, the voltage Vn4 is ELVSS+Voled. The voltage Voled varies according to the degree of degradation of the OLED. When the sixth transistor M6 is turned on, the voltages Vn4 and Vn5 of the fourth and fifth nodes N4 and N5 are changed to ELVSS+Voled, and thus the voltage Vn2 of the second node N2 is also changed. In other words, the third capacitor Cis and the sixth transistor M6 serve as a boost capacitor and a boost transistor, respectively. In calculating the voltage change of the voltage Vn2, a voltage variation of the voltage Vn2 depending on the voltage change of the fourth node N4 is ΔV6*{cs/(cs+cis)} and a voltage variation of the voltage Vn2 depending on the voltage change of the fifth node N5 is ΔV7*{cis/(cs+cis)}, where ΔV6=Voled−Vto, ΔV7=ELVSS+Voled-ELVDD, and cs denotes a composite capacitance when the first and second capacitors C1 and C2 are connected to each other in series. The voltages of the second, fourth and fifth nodes N2, N4 and N5 of the pixel circuit of FIG. 5 are summarized based on this calculation, as follows.

$$N 2 \text{:} Vn 2 = ELVSS + Vto + Vth + ( Vdata - Vref ) * \{ c 1 / ( c 1 + cis ) \} + \{ ELVDD - ( ELVSS + Vto ) \} * \{ cis / ( c 1 + cis ) \} + ( Voled - Vto ) * \{ cs / ( cs + cis ) \} + ( ELVSS + Voled - ELVSS ) * \{ cis / ( cs + cis ) \}$$

N4: Vn4=ELVSS+Voled(ΔV6=Voled−Vto)

N5: Vn5=ELVSS+Voled(ΔV7=ELVSS+Voled−ELVDD)

The voltage Vn2 of the second node N2 is the voltage of the gate electrode of the driving transistor M1, and the voltage Vn4 of the fourth node N4 is the voltage of the source electrode of the driving transistor M1. In view of a condition of c1, c2>>cis, cs>>cis, accordingly,

$$\begin{matrix}Vg = Vn 2 \\ \approx ELVSS + Vto + Vth + Vdata - Vref + ( Voled - Vto ) + \\ ( ELVSS + Voled - ELVDD ) * \{ cis / cs \} \\ = ELVSS + Vth + Vdata - Vref + Voled + \\ ( ELVSS + Voled - ELVDD ) * \{ cis / cs \} \\ Vs = Vn 4 \\ = ELVSS + Voled\end{matrix}$$

A current I flowing through the OLED according to the voltages of the driving transistor M1 is calculated as follows:

$$\begin{matrix}I = ( β / 2 ) {( Vgs - Vth )}^{2} \\ = ( β / 2 ) {( Vg - Vs - Vth )}^{2} \\ = ( β / 2 ) {\{ \begin{matrix}ELVSS + Vth + Vdata - Vref + Voled + \\ ( ELVSS + Voled - ELVDD ) ( cis / cs ) - \\ ( ELVSS + Voled ) - Vth\end{matrix} \}}^{2} \\ = ( β / 2 ) {\{ Vdata - Vref + ( ELVSS + Voled - ELVDD ) ( cis / cs ) \}}^{2} ,\end{matrix}$$

wherein β denotes a gain factor.

With the above-described current I flowing through the OLED, it may be known that the voltage Voled varying according to the degradation of the OLED is reflected in the current I.

As described above, in the pixel circuit and the pixel circuit driving method according to the embodiment of FIG. 5, the voltage change of the anode of the OLED caused due to the degradation of the OLED may be reflected in the voltage applied to the gate electrode of the driving transistor M1 by using the sixth and seventh transistors M6 and M7 and the third capacitor Cis. Accordingly, display performance of the display panel including the pixel circuit of FIG. 5 may be prevented from degrading.

Table 3 shows a result of a simulation performed on the pixel circuit of FIG. 5.

TABLE 3

| | Before degradation | After degradation |
|---|---|---|
| Vn5(V) | −6.03 | −4.59 |
| Vn2(V) | 1.69 | 2.3 |

As shown in Table 3, the voltage Vn5 increases as the OLED degrades, and the voltage Vn2 increases as the voltage Vn5 increases.

Table 4 shows a result of another simulation performed on the pixel circuit of FIG. 5.

TABLE 4

| | Vn2(V) | Vn4(V) | I(A) | ΔI(A) |
|---|---|---|---|---|
| Standard | 8.71 | 5.69 | 1.01E−06 | 0.00E+00 |
| Degradation 1 | 9.49 | 6.68 | 1.12E−06 | 1.13E−07 |
| Degradation 2 | 10.27 | 7.41 | 1.24E−06 | 2.27E−07 |

“Standard” denotes a case where no degradation of the OLED occurs, and “Degradation 1” and “Degradation 2” denote the cases where the OLED degrades. The Degradation of the OLED is greater in the case of “Degradation 2” than in the case of “Degradation 1”.

As shown in Table 4, as the voltage Vn4 increases, the voltage Vn2 increases accordingly. Accordingly, the current flowing through the OLED also increases.

Since luminous efficiency is lower in the cases where the OLED degrades than in the case where no degradation of the OLED occurs, the current flowing through the OLED is increased so that a gray level that is the same as a gray level represented in the case where no degradation of the OLED occurs is represented in a degraded OLED. Accordingly, based on Table 3 and Table 4, the capacitance cis of the third capacitor Cis is controlled to adjust the voltage variation of the voltage Vn2. As a result, the current flowing through the OLED may be controlled.

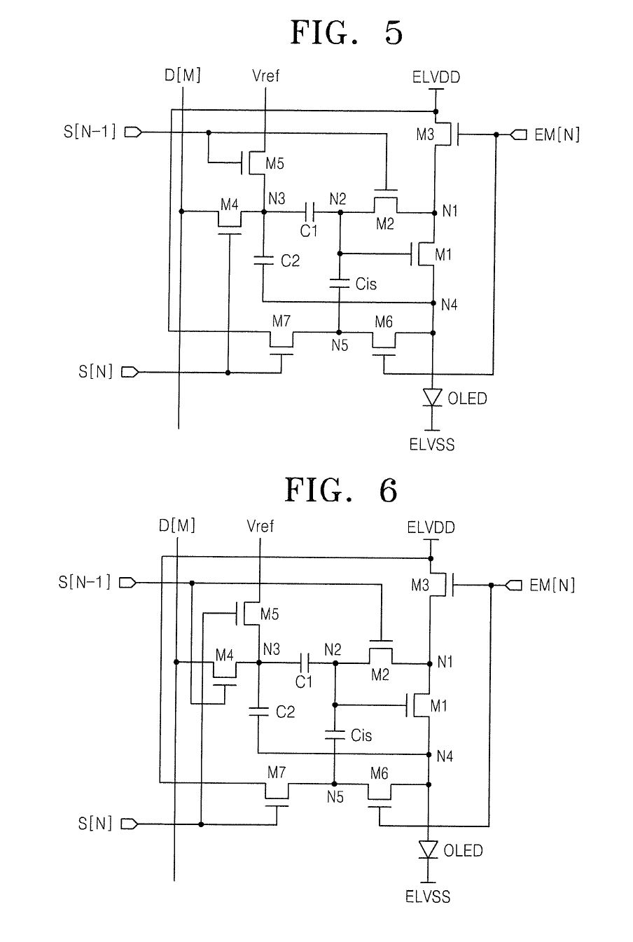

FIG. 6 is a circuit diagram of a pixel circuit of a display panel, according to another embodiment of the present invention.

Referring to FIG. 6, the pixel circuit according to another embodiment includes an OLED, first through seventh transistors M1 through M7, and first through third capacitors C1, C2 and Cis. The connections between these devices are substantially the same as those of the pixel circuit of FIG. 5. Accordingly, descriptions of the same structure and operation as those of the pixel circuit of FIG. 5 will not be repeated, and the pixel circuit according to the embodiment of FIG. 6 will now be described by focusing on differences between the pixel circuits of FIGS. 6 and 5.

In the embodiment of FIG. 6, the previous scan signal is applied to the gate electrodes of the second and fourth transistors M2 and M4. Thus, the gate electrodes of the second and fourth transistors M2 and M4 are connected to the previous scan line S[N−1].

The current scan signal is applied to the gate electrodes of the fifth and seventh transistors M5 and M7. Accordingly, the gate electrodes of the fifth and seventh transistors M5 and M7 are connected to the current scan line S[N].

The emission signal is applied to the gate electrodes of the third and sixth transistors M3 and M6. Accordingly, the gate electrodes of the third and sixth transistors M3 and M6 are connected to the emission control line EM[N].

The first power source provides the first power supply voltage ELVDD, and the second power source provides the second power supply voltage ELVSS. The second power supply voltage ELVSS may be a ground voltage GND. The reference power source may provide the reference voltage Vref, which may be a logic high voltage.

The operations of the pixel circuits of FIGS. 5 and 6 are substantially the same, and the pixel circuits of FIGS. 5 and 6 operate according to the timing diagram of FIG. 2. However, in the embodiment of FIG. 6, the fourth transistor M4 is first turned on, and the fifth transistor M5 is then turned on, and thus a current I finally flowing through the OLED is calculated as follows:

I=(β/2){Vref−Vdata+(ELVSS+Voled−ELVDD)(cis/cs)}².

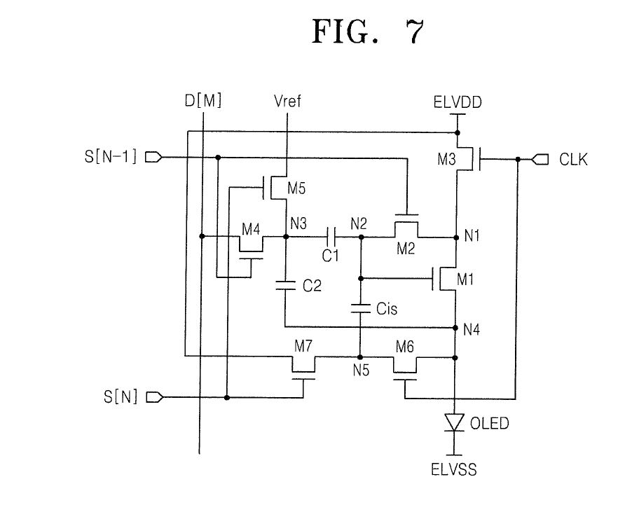

FIG. 7 is a circuit diagram of a pixel circuit of a display panel, according to another embodiment of the present invention.

Referring to FIG. 7, the pixel circuit according to another embodiment includes an OLED, first through seventh transistors M1 through M7, and first through third capacitors C1, C2 and Cis. The connections between these devices are substantially the same as those of the pixel circuit of FIG. 6. Accordingly, descriptions of the same structure and operation as those of the pixel circuit of FIG. 6 will not be repeated, and the pixel circuit according to the embodiment of FIG. 7 will now be described by focusing on differences between the pixel circuits of FIGS. 7 and 6.

In the embodiment of FIG. 7, the previous scan signal is applied to the gate electrodes of the second and fourth transistors M2 and M4. Thus, the gate electrodes of the second and fourth transistors M2 and M4 are connected to the previous scan line S[N−1].

The current scan signal is applied to the gate electrodes of the fifth and seventh transistors M5 and M7. Accordingly, the gate electrodes of the fifth and seventh transistors M5 and M7 are connected to the current scan line S[N].

In the embodiment of FIG. 7, a clock signal CLK instead of the emission signal is applied to the gate electrodes of the third and sixth transistors M3 and M6. The clock signal CLK may be generated from a system clock. In this case, a special driving unit for generating the emission signal is not used.

Like the pixel circuit of FIG. 6, a current I flowing through the OLED of the pixel circuit of FIG. 7 is calculated as follows:

I=(β/2){Vref−Vdata+(ELVSS+Voled−ELVDD)(cis/cs)}².

As described above, in the pixel circuit and the pixel circuit driving method according to the embodiment of FIG. 7, even if the types of signals applied to the second through sixth transistors M2 through M6 are changed, the voltage change of the anode of the OLED caused due to the degradation of the OLED may be reflected in the voltage applied at the gate electrode of the driving transistor M1 by using the sixth and seventh transistors M6 and M7 and the third capacitor Cis. Accordingly, display performance of the display panel including the pixel circuit of FIG. 6 or FIG. 7 may be prevented from degrading.

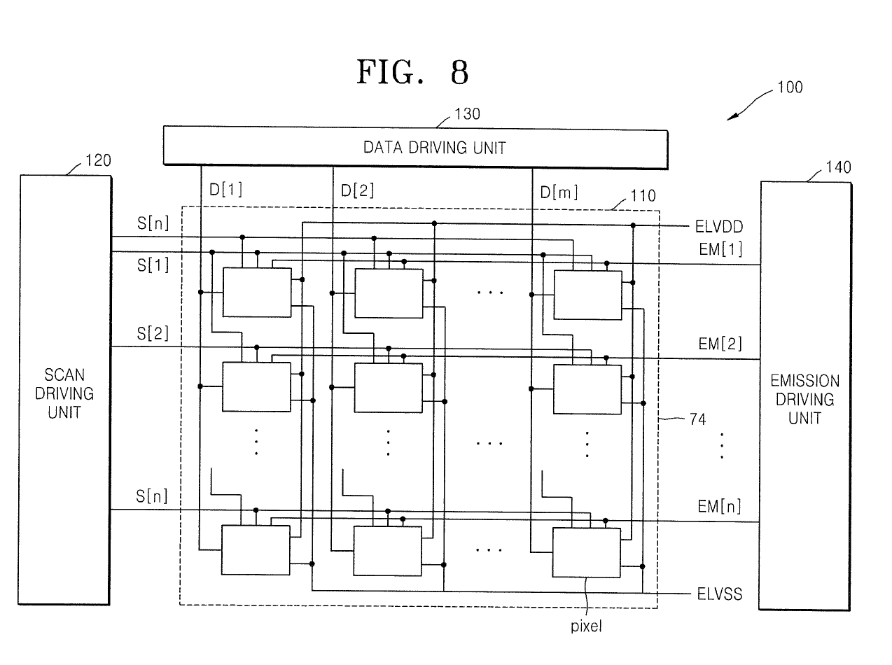

FIG. 8 is a block diagram of an organic light emitting display device 100 according to an embodiment of the present invention.

Referring to FIG. 8, the organic light emitting display device 100 according to an embodiment includes a display panel 110, a scan driving unit 120, a data driving unit 130, and an emission driving unit 140.

The display panel 110 includes n×m pixels, n scan lines S[1] . . . S[n] arranged in rows, m data lines D[1] . . . D[m] arranged in columns, n emission control lines EM[1] . . . EM[n] arranged in rows, a first power supply voltage (ELVDD) application wire, and a second power supply voltage (ELVSS) application wire. Any of the pixel circuits of FIGS. 1 and 3-7 may be formed in each of the pixels.

The scan lines S[1] . . . S[n] transmit scan signals to the pixels. The data lines D[1] . . . D[m] transmit data signals to the pixels.

The scan driving unit 120 supplies the scan signals to the scan lines S[1] . . . S[n]. The scan signals are sequentially applied to the scan lines S[1] . . . S[n], and the data signals are applied to the pixels in accordance with the scan signals.

The data driving unit 130 applies the data signals to the data lines D[1] . . . D[m]. The data signals may be output from a voltage source or a current source included in the data driving unit 130.

The emission driving unit 140 applies emission signals to the emission control lines EM[1] . . . EM[n].

Timings of the scan signals and the emission signals may be the same as those of the timing diagram of FIG. 2.

The pixels may be formed at crossing regions between the scan lines S[1] . . . S[n], the data lines D[1] . . . D[m], and the emission control lines EM[1] . . . EM[n].

As described above, the organic light emitting display device 100 according to one embodiment includes pixel circuits that can compensate for degradation of OLEDs, thereby preventing reduction of display performance.

A program for executing methods of driving pixel circuits according to the above-described embodiments and other embodiments may be stored in storage media. The storage media may include magnetic storage media (e.g., ROMs, floppy disks, hard disk, and the like) and optical storage media (e.g., CD ROMS, DVDs and the like).

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A pixel circuit for a display panel, comprising:
an organic light emitting diode (OLED) comprising an anode and a cathode;
a first NMOS transistor comprising a first electrode coupled to a first node, a second electrode coupled to the anode of the OLED, and a gate electrode coupled to a second node;
a second NMOS transistor comprising a first electrode coupled to the second node, a second electrode coupled to the first node, and a gate electrode;
a third NMOS transistor comprising a first electrode coupled to a first power source, a second electrode coupled to the first node, and a gate electrode;
a fourth NMOS transistor comprising a first electrode coupled to a data line, a second electrode coupled to a third node, and a gate electrode;
a fifth NMOS transistor comprising a first electrode coupled to a reference power source, a second electrode coupled to the third node, and a gate electrode;
a sixth NMOS transistor comprising a first electrode, a second electrode coupled to the anode of the OLED, and a gate electrode;
a first capacitor coupled between the second node and the third node;
a second capacitor coupled between the third node and the anode of the OLED; and
a third capacitor coupled between the second node and the first electrode of the sixth NMOS transistor.

2. The pixel circuit of claim 1, wherein the gate electrode of the second NMOS transistor and the gate electrode of the fifth NMOS transistor are configured to receive a previous scan signal.

3. The pixel circuit of claim 2, wherein the gate electrode of the fourth NMOS transistor is configured to receive a current scan signal.

4. The pixel circuit of claim 3, wherein the gate electrode of the third NMOS transistor and the gate electrode of the sixth NMOS transistor are configured to receive an emission signal.

5. The pixel circuit of claim 4, further comprising a seventh NMOS transistor comprising a first electrode coupled to the first power source, a second electrode coupled to the first electrode of the sixth NMOS transistor, and a gate electrode configured to receive the current scan signal.

6. The pixel circuit of claim 5, wherein the reference power source has a ground voltage.

7. The pixel circuit of claim 1, wherein the gate electrode of the second NMOS transistor and the gate electrode of the fourth NMOS transistor are configured to receive a previous scan signal.

8. The pixel circuit of claim 7, wherein the gate electrode of the fifth NMOS transistor is configured to receive a current scan signal.

9. The pixel circuit of claim 8, wherein the gate electrode of the third NMOS transistor and the gate electrode of the sixth NMOS transistor are configured to receive an emission signal.

10. The pixel circuit of claim 8, wherein the gate electrode of the third NMOS transistor and the gate electrode of the sixth NMOS transistor are configured to receive an external clock signal.

11. The pixel circuit of claim 9, further comprising a seventh NMOS transistor comprising a first electrode coupled to the first power source, a second electrode coupled to the first electrode of the sixth NMOS transistor, and a gate electrode configured to receive the current scan signal.

12. The pixel circuit of claim 11, wherein the reference power source has a logic high signal.

13. The pixel circuit of claim 1, wherein the first electrode of the first NMOS transistor comprises a drain electrode and the second electrode of the first NMOS transistor comprises a source electrode.

14. The pixel circuit of claim 1, wherein capacitances of the first and second capacitors are greater than capacitance of the third transistor.

15. A method of driving a pixel circuit comprising an OLED having an anode and a cathode, a driving transistor, a plurality of switching transistors, a booster transistor having a first electrode, a second electrode coupled to the anode of the OLED, and a gate electrode, a plurality of capacitors, and a booster capacitor coupled between the gate electrode of the driving transistor and the first electrode of the booster transistor,
wherein the driving transistor, the plurality of switching transistors and the booster transistor are NMOS transistors, the method comprising:
turning on the booster transistor when a previous scan signal and a current scan signal are logic low and an emission signal is logic high; and
transmitting a voltage change at the anode of the OLED to the gate electrode of the driving transistor via coupling of the booster capacitor.

16. The method of claim 15, wherein the voltage change at the anode of the OLED corresponds to a voltage difference between a voltage at the anode when substantially no current flows through the OLED and a voltage at the anode when a current flows through the OLED.

17. The method of claim 15, further comprising initializing the pixel circuit when the previous scan signal and the emission signal are logic high and the current scan signal is logic low.

18. The method of claim 15, further comprising diode-connecting the driving transistor to compensate for a threshold voltage of the OLED when the previous scan signal is logic high and the current scan signal and the emission signal are logic low.

19. The method of claim 15, further comprising performing data writing when the previous scan signal and the emission signal are logic low and the current scan signal is logic high.

20. An organic light emitting display device comprising:
a scan driver for providing scan signals to a plurality of scan lines;
an emission driver for providing emission signals to a plurality of emission control lines;
a data driver for providing data signals to a plurality of data lines; and
a plurality of pixel circuits at crossing regions between the scan lines, the emission control lines, and the data lines,
wherein each of the pixel circuits comprises:
an organic light emitting diode (OLED) comprising an anode and a cathode;
a first NMOS transistor comprising a first electrode coupled to a first node, a second electrode coupled to the anode of the OLED, and a gate electrode coupled to a second node;
a second NMOS transistor comprising a first electrode coupled to the second node, a second electrode coupled to the first node, and a gate electrode;
a third NMOS transistor comprising a first electrode coupled to a first power source, a second electrode coupled to the first node, and a gate electrode;
a fourth NMOS transistor comprising a first electrode coupled to a data line, a second electrode coupled to a third node, and a gate electrode;
a fifth NMOS transistor comprising a first electrode coupled to a reference power source, a second electrode coupled to the third node, and a gate electrode;
a sixth NMOS transistor comprising a first electrode, a second electrode coupled to the anode of the OLED, and a gate electrode;
a first capacitor coupled between the second node and the third node;
a second capacitor coupled between the third node and the anode of the OLED; and
a third capacitor coupled between the second node and the first electrode of the sixth NMOS transistor.

21. The organic light emitting display device of claim 20, wherein:
the gate electrode of the second NMOS transistor and the gate electrode of the fifth NMOS transistor are connected to an (N−1)th scan line;
the gate electrode of the third NMOS transistor and the gate electrode of the sixth NMOS transistor are coupled to an N-th emission control line; and
the gate electrode of the fourth NMOS transistor is coupled to an N-th scan line.

22. The organic light emitting display device of claim 20, wherein:
the gate electrode of the second NMOS transistor and the gate electrode of the fourth NMOS transistor are coupled to an (N−1)th scan line;
the gate electrode of the third NMOS transistor and the gate electrode of the sixth NMOS transistor are coupled to an N-th emission control line; and
the gate electrode of the fifth NMOS transistor is coupled to an N-th scan line.

23. The organic light emitting display device of claim 21, further comprising a seventh NMOS transistor comprising a first electrode coupled to the first power source, a second electrode coupled to the first electrode of the sixth NMOS transistor, and a gate electrode coupled to the N-th scan line.

24. The organic light emitting display device of claim 22, further comprising a seventh NMOS transistor comprising a first electrode coupled to the first power source, a second electrode coupled to the first electrode of the sixth NMOS transistor, and a gate electrode coupled to the N-th scan line.

25. The organic light emitting display device of claim 20, wherein the first electrode of the first NMOS transistor comprises a drain electrode and the second electrode of the first NMOS transistor comprises a source electrode.

26. The organic light emitting display device of claim 20, wherein capacitances of the first and second capacitors are greater than capacitance of the third transistor.
